(19) United States
(12) Patent Application Publication
(10) Pub. No.: US 2025/0005403 A1
(43) Pub. Date: Jan. 2, 2025

(54) ESTIMATING GRANGER-CAUSAL RELATIONSHIP AMONG EVENT INSTANCES

(71) Applicant: INTERNATIONAL BUSINESS MACHINES CORPORATION, ARMONK, NY (US)

(72) Inventors: Dongxia Wu, La Jolla, CA (US); Tsuyoshi Ide, Harrison, NY (US); Aurelie Chloe Lozano, Scarsdale, NY (US); Georgios Kollias, White Plains, NY (US); Jiri Navratil, Cortlandt Manor, NY (US); Naoki Abe, Rye, NY (US)

(21) Appl. No.: 18/346,198

(22) Filed: Jun. 30, 2023

(51) Int. Cl. G06N 5/043; G06N 7/01

(52) U.S. Cl. CPC G06N 5/043; G06N 7/01

(57) ABSTRACT

A computer-implemented method for discovering causality includes accessing time-series data describing past events. The time-series data is input into a machine learning model, the machine learning model implementing an intensity function including a kernel function, where the kernel function determines a causal strength value computed from a transformer model, and where the kernel function contributes to an additive function that sums intensity of repeated individual events of the past events. In response to the inputting, an output is received from the machine learning model that indicates a causality that links two or more events of the past events.

### BACKGROUND

The present disclosure generally relates to the determination of causal relationships among event instances, and more particularly, to a computer-implemented method, a computer system, and a computer program product for providing a process model that allows direct instance-wise causal analysis without post-processing.

### SUMMARY

In one embodiment, a system and method are provided that can provide a process model that allows direct instance-wise causal analysis of noisy time-series data, without the need for post-processing. As used herein, “noisy” time-series data refers to random fluctuations in the time series about its typical pattern.

In one embodiment, a computer-implemented method for discovering causality includes accessing time-series data describing past events. The time-series data is input into a machine learning model, the machine learning model implementing an intensity function including a kernel function, where the kernel function determines a causal strength value computed from a transformer model, and where the kernel function contributes to an additive function that sums intensity of repeated individual events of the past events. In response to the inputting, an output is received from the machine learning model that indicates a causality that links two or more events of the past events.

In another embodiment, a system includes a processor, a data bus coupled to the processor, a memory coupled to the data bus, and a computer-usable medium. embodying computer program code. The computer program code including instructions executable by the processor and configured for accessing time-series data describing past events. The time-series data is input into a machine learning model, the machine learning model implementing an intensity function including a kernel function, where the kernel function determines a causal strength value computed from a transformer model, and where the kernel function contributes to an additive function that sums intensity of repeated individual events of the past events. In response to the inputting, an output is received from the machine learning model that indicates a causality that links two or more events of the past events.

The above method can be performed on a system having non-transitory computer readable storage medium tangibly embodying a computer readable program code having computer readable instructions that, when executed, causes a computer device to provide a process that allows direct instance-wise causal analysis without the need for post-processing.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows an instance-wise Self-attentive Hawkes Processes (ISAHP) architecture, consistent with an illustrative embodiment;

FIG. 2 shows a table of hyperparameter configurations, consistent with an illustrative embodiment;

FIG. 3 shows a table of results for Granger causality discovery, comparing the methods of the present disclosure with conventional processes, consistent with an illustrative embodiment;

FIG. 4 shows a table of results for prediction accuracy, comparing the methods of the present disclosure with conventional processes, consistent with an illustrative embodiment;

FIG. 5 shows instance-level causality analysis, where the weight of the edge from the first event to the third is what is compared for the synergistic (left) and non-synergistic (right) sequences, where underscored numbers represent successful cases and box-enclosed numbers represent failure cases, consistent with an illustrative embodiment;

FIG. 6 shows a table of averaged ratios between scores, comparing the methods of the present disclosure with conventional processes, consistent with an illustrative embodiment;

FIG. 7 shows a table of results from an ablation study on type-level regularization (TLR), consistent with an illustrative embodiment; and

FIG. 8 is a functional block diagram illustration of a computer hardware platform that can be used to implement the method for determining time-series data causality, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

Broadly, aspects of the present disclosure provide systems and methods that can provide a process model that allows direct instance-wise causal analysis without the need for post-processing.

According to an aspect of the present disclosure, there is provided a computer-implemented method for discovering causality that includes accessing time-series data describing past events and inputting the time-series data into a machine learning model. The machine learning model implements an intensity function including a kernel function, where the kernel function determines a causal strength value computed from a transformer model, and where the kernel function contributes to an additive function that sums intensity of repeated individual events of the past events. In response to the inputting, an output is received from the machine learning model that indicates a causality that links two or more events of the past events. The computer-implemented method provides a deep Hawkes processes that can admit instance-wise Granger-causal interpretation.

In embodiments, which can be combined with the preceding embodiment, the intensity refers to a probability density of an occurrence of an event. The intensity function describes the probability density of the next occurrence of an event at a future time point t, and is assumed to have a specific parametric form for causal discovery.

In embodiments, which can be combined with the preceding embodiments, the transformer model implements self-attention. By leveraging the self-attention mechanism of the transformer, the method can provide causal discovery for instance-type data.

In embodiments, which can be combined with the preceding embodiments, the self-attention is implemented via

$$A ( x , {x}_{j} ) = \frac{exp ( {x}^{T} {Kx}_{j} ) ( t > {t}_{j} )}{{\sum }_{l : {t}_{l} < t} exp ( {x}^{T} {Kx}_{l} )} ,$$

where t is a timestamp associated with x, and [symbol] (t>tⱼ) is an indicator function that assumes a value 1 if an argument, t>tⱼ, is true and 0 otherwise, and a transformer, K is a parameter matrix learned from data. To capture complex causal interactions potentially involving multiple events, the self-attention mechanism of the transformer K can be used.

In embodiments, which can be combined with the preceding embodiments, the transformer, K, corresponds to W_{Q}W_{K}^{T}, where W_{Q} and W_{K} are transformation matrices for queries and keys, respectively. By leveraging the self-attention mechanism of the transformer, the requirements of Granger causality can be met.

In embodiments, which can be combined with the preceding embodiments, the transformer model implements a key-value-query formalism. To capture various dependencies, a neural architecture is introduced based on self-attention to parametrize Equation (1), described below, where an embedding approach follows the key-value-query formalism of the transformer. In embodiments, which can be combined with the preceding embodiments, the intensity function further comprises a decay function that contributes to the additive function. The decay function the decay function represents a time-decay of the causal influence.

In embodiments, which can be combined with the preceding embodiments, the decay function comprises a decay distribution ϕ(t-tⱼ|x, xⱼ) that models a time decay of causal influence. Such a decay distribution can be helpful to model the time decay of causal influence.

In embodiments, which can be combined with the preceding embodiments, the decay distribution ϕ(t-tⱼ|x, xⱼ) is a truncated Gaussian mixture. The truncated Gaussian mixture may be helpful to model the time decay of causal influence.

In embodiments, which can be combined with the preceding embodiments, where

$$ϕ ( t - {t}_{j} \vert x , {x}_{j} ) = γ ( x , xj ) {e}^{- γ ( x , {x}_{j} ) ( t - {t}_{j} )} ,$$

where γ(x, xⱼ) is a decay rate function. Such a decay distribution can be helpful model the time decay of causal influence.

In embodiments, which can be combined with the preceding embodiments, the method can further include adopting an instance-aware parameterization of a kernel function, where each event is associated with a latent embedding vector x=g(t, k) and an embedding function g(t, k) is defined as:

$$g ( t , k ) = MLP [ t - {t}_{i} ⊕ MLP ( k ) ]$$

with an event type provided as a K-dimensional one-hot vector and a time difference provided as tᵢ-tᵢ₋₁, for xᵢ, and one multilayer perceptron (MLP) layer is used to embed the K-dimensional one-hot vector for the event type. The one MLP layer can be concatenated with the time difference to form a M-dimensional embedding vector for each event (t, k). The instance-wise parameterization of the kernel function can provide a process for prediction a future event in the time-series data having instance-level causality.

In embodiments, which can be combined with the preceding embodiments, an intensity function for a latent event vector embedding x is in a form of:

$$λ ( x \vert {t}_{} ) = μ ( x \vert {t}_{} ) + {\sum }_{j : {t}_{j} < t} α ( x , {x}_{j} ) ϕ ( t - {t}_{j} \vert x , {x}_{j} )$$

where μ is a background intensity, a function α(x, xⱼ)εR₊, where R₊ denotes a set of nonnegative real numbers, is the kernel function, and a decay distribution ϕ(t-tⱼ|x, xⱼ) models a time decay of causal influence. The additive structure of the intensity function helps provide the ability for determining instance-level causality.

In embodiments, which can be combined with the preceding embodiments, an output of the machine learning model is used, without any post-processing, to provide the output of the instance-level causality. This can reduce computational overhead for providing the instance-level causality.

In embodiments, which can be combined with the preceding embodiments, the additive function is disposed inside a nonlinear function.

According to an aspect of the disclosure, there is provided a system includes a processor, a data bus coupled to the processor, a memory coupled to the data bus, and a computer-usable medium embodying computer program code. The computer program code includes instructions executable by the processor and configured for accessing time-series data describing past events. The time-series data can be input into a machine learning model, where the machine learning model implements an intensity function including a kernel function, where the kernel function determines a causal strength value computed from a transformer model, and where the kernel function contributes to an additive function that sums intensity of repeated individual events of the past events. In response to the inputting, output is received from the machine learning model that indicates a causality that links two or more events of the past events.

According to an aspect of the disclosure, there is provided a computer program product for discovering causality, the computer program product including a computer readable storage medium having program instructions embodied therewith, the program instructions executable by a computer to cause the computer to access time-series data describing past events. The time-series data can be input into a machine learning model, the machine learning model implementing an intensity function including a kernel function, where the kernel function determines a causal strength value computed from a transformer model, and where the kernel function contributes to an additive function that sums intensity of repeated individual events of the past events. In response to the input, an output is received from the machine learning model that indicates a causality that links two or more events of the past events.

In embodiments, which can be combined with the preceding embodiment, the intensity refers to a probability density of an occurrence of an event. The intensity function describes the probability density of the next occurrence of an event at a future time point t, and is assumed to have a specific parametric form for causal discovery.

In embodiments, which can be combined with the preceding embodiments, the transformer model implements self-attention. By leveraging the self-attention mechanism of the transformer, the method can provide causal discovery for instance-type data.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may provide a process model that allows direct instance-wise causal analysis without the need for post-processing. This may have the technical effect of significantly reducing computing resources and overhead required for providing causal analysis at an instance-wise level, as conventional post-process is not required with the systems and methods according to the present disclosure.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

For instance-level causal analysis, there are three lines of research to date. One is based on the classical Hawkes process, typically through the minorization-maximization (MM) framework. A classical Hawkes model, however, places a linearity assumption in the intensity function, limiting its expressive power. Neural point process models are designed to address this limitation, but they typically embed event history in the form of a latent state vector, losing instance-wise information. As a result, the attention-based score does not necessarily represent the Granger causality. The third line of research is based on a post-processing step following maximum likelihood, which incurs additional computational cost.

Embodiments of the present disclosure, as described in greater detail below, provide a novel deep Hawkes process model, referred to herein as the “instance-wise self-attentive Hawkes process” (ISAHP), that achieves better expressiveness while also enabling direct instance-level Granger-causal analysis. From a mathematical perspective, one design principle of the ISAHP is to maintain an additive structure, where causal interaction is represented as the summation over individual historical events. To capture complex causal interactions potentially involving multiple events, aspects of the present disclosure can leverage the self-attention mechanism of a transformer model. ISAHP can directly capture instance-wise causal relationships with its additive structure. ISAHP can also easily obtain type-level causal relationships by simple aggregation. ISAHP provides a deep point process model that allows direct instance-wise causal analysis without post-processing.

As described in the experiments below, it was empirically demonstrated that ISAHP can discover complex instance-level causal structures that cannot be handled by the classical models and neural point process models without post-processing. The experiments also show that ISAHP achieves state-of-the-art performance in two proxy tasks, one involving type-level causal discovery and another involving instance-level event type prediction. This confirms that the instance- and type-level causal inference tasks are coupled and the framework of the present disclosure can manage to model both the instance-and type-level causal inference tasks coherently and holistically.

As a result of discovering complex instance-level causal structures, aspects of the present disclosure can find use in various applications, including applications concerning event diagnosis, including condition-based monitoring systems (semiconductor tools, offshore oil rigs, cement mill, and the like), consumer churn analysis, viral propagation in social media, artificial intelligence operations (AIOps), medical diagnosis, fraud detection, and intrusion detection. Applications of the methods of the present disclosure can also include event consolidation tasks (according to causal dependency)/root-cause analysis in fields such as AIOps, condition-based monitoring systems, anomaly sequence detection, fake account/posts detection in social media, next event detection, viral marketing, contextual product recommendation, analytics tool recommendation on cloud system, and customer targeting, for example. In some embodiments, these applications may automatically use the causal discoveries made by the methods of the present disclosure.

Type-Level Granger Causality. A training data set D with S event sequences, each of which contains Lₛ events, such that

$$𝒟 {=}^{△} \{ ( {t}_{i}^{s} , {k}_{i}^{s} ) \vert i ∈ \{ 1 , … , {L}_{s} \} , s ∈ \{ 1 , … , S \} \} . \qquad ( 1 )$$

In the data set, each event is represented by its timestamp of occurrence t and a type attribute k. The timestamps are sorted so that tᵢ^{s}≥tⱼ^{s} for I>j. It can be assumed that the total number of event types is K and hence kᵢ^{s}ε{1, . . . , K}.

The problem of causal discovery can be formalized from event sequences as a unsupervised density estimation task of a point process model. Given the event history [symbol] ₜ={(tᵢ^{s}, kᵢ^{s})ₜ_{_{i<t}}}, temporal point processes are generally characterized by a conditional distribution called the intensity function λₖ (t| [symbol] ₜ). The intensity function describes the probability density of the next occurrence of type-k event at a future time point t, and is assumed to have a specific parametric form for causal discovery. For classical multivariate Hawkes process (MHP), a simple linear form can be assumed, where an additive form in of the MPH naturally leads to causal interpretation among event types.

Instance Level Granger Causality. Although MHP can provide Granger causality interpretations for event sequences, such a causality structure is only at the type-level, not for individual events. To obtain instance-level causality, a direct generalization of MHP for an event i with event type k would be

$${λ}_{i , k} ( t \vert {t}_{} ) = {μ}_{i , k} + {\sum }_{i : {t}_{i} < t} {α}_{i , j , k ,} {ϕ}_{i , j , k} ( t - {t}_{j} ) \qquad ( 2 )$$

In the equation above, μ_{i,k} is the background intensity for event i with event type k, {α_{i,j,k,}} forms a L×L×K tensor representing instance-level Granger causality, and ϕ_{i,j,k} (□) is the decay function representing time-decay of the causal influence. A maximum sequence length L=max({Ls}) is assumed and padding is used for varying length sequences.

In instance-level causal analysis, the unsupervised causal discovery problem can be reduced to fitting the model parameters contained in the intensity function λ_{i,k} (t| [symbol] ₜ). However, such an instance level causal analysis is very challenging. First, capturing long-range causality between events can be difficult due to the intricate nature of temporal dependencies. Second, it requires a substantial number of parameters to adequately parameterize the model, increasing the risk of overfitting. According to aspects of the present disclosure, a particular parametric form is used for λ_{i,k} (t| [symbol] ₜ) and regularization terms are used to mitigate the overfitting issue.

### Instance-Wise Self-Attentive Hawkes Process

Given a set of interacting event sequences, {(tᵢ^{s}, kᵢ^{s})|s=1, . . . , S; i=0, 1, . . . , Lₛ}, where tᵢ^{s} is a timestamp of the i-th event in the s-th sequence and kᵢ^{s} is an event type (one of 1, . . . , K), aspects of the present disclosure can find an instance-level causal association strength of any event in the data set.

Intensity Function. One feature of ISAHP is that it maintains an additive structure over the historical events in the intensity function, similar to a multivariate Hawkes process (MHP). Hence, ISAHP inherits the interpretability of MHP for Granger causality. Another feature of ISAHP is that it adopts a particular form of instance-aware parameterization of the kernel function. Specifically, each event is associated with a latent embedding vector x=g(t, k) and the embedding function g(t, k) is defined as:

$$g ( t , k ) = MLP [ t - {t}_{i} ⊕ MLP ( k ) ]$$

with the event type (as a K-dimensional one-hot vector) and the time difference (as tᵢ-tᵢ₋₁ for xᵢ). One multilayer perceptron (MLP) layer can be used to embed the one-hot vector for event type and concatenate it with the time difference to form a M-dimensional embedding vector for each event (t, k). It is assumed that the intensity function for an event embedding x in the form of:

$$λ ( x \vert {ℋ}_{t} ) = μ ( x \vert {ℋ}_{t} ) + {\sum }_{j : {t}_{j} < t} α ( x , {x}_{j} ) ϕ ( t - {t}_{j} \vert x , {x}_{j} ) \qquad ( 3 )$$

where μ is the background intensity, the function a (x, xⱼ)εR₊ (where R₊ denotes the set of nonnegative real numbers) is called the kernel function. The kernel function characterizes instance-level causal influence between events, generalizing the vanilla MHP, whose kernel matrix depends only on event types. The decay distribution ϕ(t-tⱼ|x, xⱼ) models the time decay of causal influence. In general, ϕ can be any distribution, such as a truncated Gaussian mixture, depending on the statistical nature of the training dataset D. In experiments, a “neural exponential distribution” was assumed as:

$$ϕ ( t - {t}_{j} \vert x , {x}_{j} ) = γ ( x , xj ) {e}^{- γ ( x , {x}_{j} ) ( t - {t}_{j} )} , \qquad ( 4 )$$

where γ(x, xⱼ) is called the decay rate function. Neural networks can be used to model the functions γ(x, xⱼ), μ(x| [symbol] ₜ) and α(x, xⱼ), which will be discussed below.

In the Hawkes-type model, event occurrence probability includes two components: the spontaneous effect (the μ term) and the causal effects (the α term). While it is true that μ includes the elements of the self-attention, A, (discussed in greater detail below) in average/aggregation, the individual causal effects can be captured by explicitly including the α's. Regularized maximum likelihood estimation (MLE) can resolve this judgement near-optimally and, hence, admits the reasonable interpretation that α_{x,x}_{ⱼ}=0 indicates Granger non-causality at instance level.

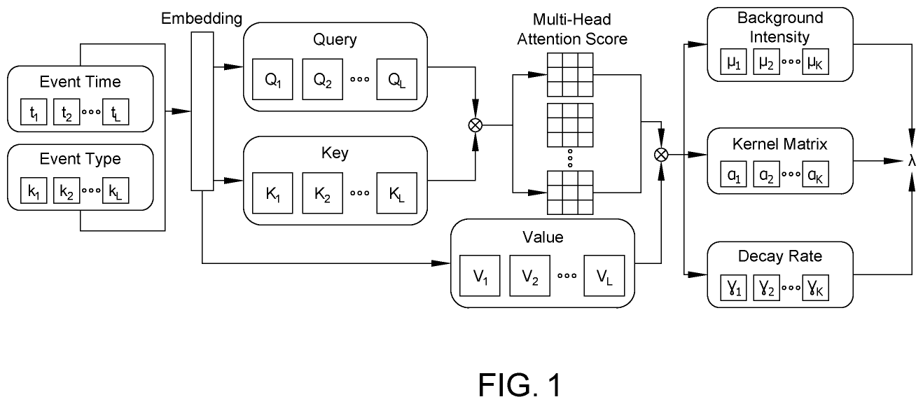

Self-attentive Architecture. In the instance-wise additive form, capturing event-event interdependency is important. There may be short-term temporal dependencies that the classical linear Hawkes models could catch, or there may be non-trivial long-range temporal dependencies involving multiple event instances. To capture such various dependencies, a neural architecture is introduced based on self-attention to parametrize Equation (1). FIG. 1 illustrates the model architecture with particular attention to the data structure in the training phase. As described in FIG. 1, the embedding approach follows the key-value-query formalism of the transformer.

The embedding vectors {xⱼ}ⱼ₌₁^{L} are linearly transformed to be the “value” vector:

$${v}_{j} = {W}_{V}^{T} {x}_{j} , or V = {W}_{V}^{T} X , \qquad ( 5 )$$

where T denotes the transpose of vectors and matrices, X [symbol] [x₁, . . . , x_{L}]ε [symbol] ^{M X L} and V≙[v, . . . , v_{L}]ε [symbol] ^{M}^{ᵥ}^{X L}, Wᵥε [symbol] ^{M X M}^{ᵥ} is learned from the data. [symbol] denotes the set of real numbers.

The dependency amount between events can be captured through “self-attention” A(x, xⱼ)ε [symbol] , defined by

$$A ( x , {x}_{j} ) = \frac{exp ( {x}^{T} {Kx}_{j} ) 𝕀 ( t > {t}_{j} )}{{\sum }_{l : {t}_{l} < t} exp ( {x}^{T} {Kx}_{l} )} , \qquad ( 6 )$$

where t is the timestamp associated with x, and [symbol] (t>tⱼ) is the indicator function that assumes the value 1 if the argument is true and 0 otherwise. Kε [symbol] ^{M X M} is a parameter matrix learned from the data. In the standard notation of the transformer, K corresponds to W_{Q}W_{K}^{T}, where W_{Q} and W_{K} are the transformation matrix for the queries and keys, respectively. As suggested in FIG. 1, the self-attention weights are concisely represented as an L×L matrix A=[A_{i,j}] in the training phase with A_{i,j} [symbol] A(xᵢ, xⱼ). For K types of event, multi-head attention with K different heads can be used.

Kernel matrix, background intensity, and decay rate functions. Now, γ(x, xⱼ), μ(x| [symbol] ₜ) and α(x, xⱼ) in Equation (3) and Equation (4) according to the self-attentive architecture. For the background intensity function, the following form can be used

$$μ ( x \vert {ℋ}_{t} ) = {\overline{μ}}_{k} + σ ( {( {w}_{k}^{μ} )}^{T} {\sum }_{j : {t}_{j} < t} A ( x , {x}_{j} ) {v}_{j} ) . \qquad ( 7 )$$

Here, μ̅ₖ is the background intensity, and k is the event type encoded in x. The second term represents instance-specific effects in the background intensity, where σ (□) denotes an activation function. In the implementation according to embodiments of the present disclosure, the sigmoid function was used. This term represents the averaged effect of causal interactions among the events. wₖ^{μ}ε [symbol] ^{M}^{ᵥ} is learned from the data.

For the impact and decay rate functions, the following instance-specific form was used:

$$α ( x , {x}_{j} ) = {σ}_{+} ( A ( x , {x}_{j} ) {( {w}_{k}^{α} )}^{T} {v}_{j} ) , γ ( x , {x}_{j} ) = {σ}_{+} ( A ( x , {x}_{j} ) {( {w}_{k}^{γ} )}^{T} {v}_{j} + {b}_{k}^{γ} ) . \qquad ( 8 )$$

where σ₊ σ+(□) is the softplus function applied element-wise on the vector argument, and the parameter vectors and matrices {wₖ^{α}, wₖ^{γ}, bₖ^{γ}}ₖ₌₁^{K} are learned from the data. The input of these MLPs is A(x, xⱼ)vⱼ, which can be viewed as a relevant component of vⱼ in terms of the impact on the target event represented by x. To see how this model generalizes the vanilla MHP, imagine that σ+(□) were the identity function. Then, α(x, xⱼ)→A(x, xⱼ)w̅_{k,j}^{α}, where w̅_{k,j}^{α} [symbol] (wₖ^{α})^{T} vⱼ. By construction, the attention weight A(x, xⱼ) represents the similarity between x and xⱼ. On the other hand, w̅_{k,j}^{α}, can be interpreted as the relevance of vⱼ to type-k events computed through the vector inner product. Compared with MHP's αk, kⱼ, which depends only on the event types, one can see that ISAHP looks at events at a finer granularity by using the embedding vectors.

Maximum Likelihood Estimation. Equation (3) can be learned based on maximum likelihood estimation (MLE). To present the final objective function, the sequence index, s, can be restored hereafter. The main outcome of the unsupervised causal discovery task is α_{i,j}^{s}≙α(xᵢ^{s}, xⱼ^{s}), which quantifies the instance-level causal influence of the j-th event on the i-th event. As judged from Equation (3), α_{i,j}^{s}=0 meets the definition of Granger-non-causality.

As a side product, the type-level causal dependency, denoted by α̅_{k,k′}, can be obtained as the average of instance-level causal influence:

$${\overline{α}}_{k , {k}^{′}} {=}^{Δ} \frac{1}{{N}_{k , {k}^{′}}} {\sum }_{s = 1}^{S} {\sum }_{i = 1}^{{L}_{s}} {\sum }_{j = 0}^{i} {δ}_{{k}_{s}^{j} , k} {δ}_{{k}_{i}^{s} , k} {α}_{i , j}^{s} . \qquad ( 9 )$$

where the deltas are Kronecker's deltas that are 1 if kⱼ^{s}=k and 0 otherwise. N_{k,k′} is the total counts of the event type pair (k, k′) in the dataset, defined by

$${N}_{k , {k}^{′}} {=}^{Δ} {\sum }_{s = 1}^{S} {\sum }_{i = 1}^{{L}_{s}} {\sum }_{j = 0}^{i} {δ}_{{k}_{s}^{j} , k} {δ}_{{k}_{i}^{s} , k} .$$

The final loss function to be minimized is now given by

$$ℒ = {\sum }_{k - 1}^{K} {\sum }_{{k}^{′} = 1}^{K} ( {ω}_{1} \vert {\overline{α}}_{k , {k}^{′}} \vert + {ω}_{2} {σ}_{k , {k}^{′}}^{2} ) + {\sum }_{s = 1}^{S} {\sum }_{i = 1}^{{L}_{s}} [ [ {\int }_{{t}_{i - 1}^{s}}^{{t}_{i}^{s}} {dt}^{′} λ ( {t}^{′} , {x}_{i}^{s} \vert {ℋ}_{{t}_{i}^{s}} ) - ln λ ( {t}_{i}^{s} , {x}_{i}^{s} \vert {ℋ}_{{t}_{i}^{s}} ) ] \qquad ( 10 )$$

where ω₁ and ω₂ are the regularization strengths treated as hyperparameters. In the first term of Equation (10), regularization terms are introduced for numerical stability and consistency within the same event type pair. Specifically, the type-level regularization (TLR) term ω₁|α̅_{k,k′}| is L₁ regularization on the mean of α's sharing the same event type pair. The variance regularization term is also included, with σ_{k,k′}² defined as

$${σ}_{k , {k}^{′}}^{2} {=}^{Δ} \frac{1}{{N}_{k , {k}^{′}}} {\sum }_{s , i , j} {δ}_{{k}_{s}^{j} , k} {{δ}_{{k}_{i}^{s} , k} ( {α}_{i , j}^{s} - {\overline{α}}_{k , {k}^{′}} )}^{2} . \qquad ( 11 )$$

to control the variability within the event instances of the same event type pair (k, k′). As the hyperparameter ω₂ is increased, ISAHP is encouraged to provide a generative process that is similar to the vanilla MHP for a given decay model. The rest part of Equation (10) corresponds to the negative log likelihood function, where the relationship between the intensity function and the log likelihood function was used. The integral can be performed analytically for the neural exponential distribution.

### Experiments

Granger causality inference was evaluated at both the type level and instance level to verify that (a) ISAHP outperforms other baselines for the type-level causality discovery task; (b) there is a positive correlation between performances in type-level Granger causality inference and instance level event type prediction, allowing ISAHP to accurately predict the type of next event instance; and (c) ISAHP can capture complex synergistic causal effects over multiple event types at the instance level.

Experimental Set-Up. For empirical validation, two datasets of different sizes were used: Synergy and Meme tracker (MT). These two datasets were chosen since they contain non-linear causal interactions that are challenging for classical models hence motivating a new solution approach. They are also the only datasets with non-linear causality that requires instance-level causality analysis.

ISAHP was compared with six baselines: Three from the category of the classical MHP and three from the NPP family. (1) HExp: MHP with the exponential decay model. (2) HSG: MHP with a Gaussian mixture decay, which is known as the state-of-the-art parametric model for Granger causality in the classical MHP. (3) CRHG: A sparse Granger-causal learning framework based on a cardinality-regularized Hawkes process. Note that CRHG is designed to learn from a single event sequence. To incorporate this baseline into type-level causality analysis, sequences from the dataset were concatenated to form a long sequence. (4) RPPN: Recurrent Point Process Networks, an RNN (recurrent neural network)-based NPP that supports Granger causality inference based on an added attention layer. (5) SAHP: Self-Attentive Hawkes Process, a transformer-based NPP that enables Granger causality analysis based on the attention mechanism. It directly uses the self-attention from its transformer architecture to aggregate the influence from historical events in determining the intensity function for the next event. (6) CAUSE: Causality from attributions on sequence of events, an RNN-based framework for inferring Granger causality. It includes a post-training step to infer the instance-level Granger causality using an attribution method called the integrated gradient. It should be noted that ISAHP does not require any post-training step and can directly infer the instance-level Granger causality based on its additive intensity function.

Three different experiments were conducted to validate the ISAHP in addition to an ablation study to validate TLR. While the main motivation of ISAHP is instance-level Granger-causal analysis, proxy tasks involving type-level inference were included as well as instance level event type prediction, due to the scarcity of ground truth data on instance-level causality.

The first experiment was type-level Granger causal discovery. The area under the curve (AUC) of the true positive vs. false positive curve and Kendall's τ coefficient were used to measure the accuracy of the inferred Granger causality matrix compared to the ground truth. The second experiment was next event-type prediction. This can be reduced to a multi-class classification problem given its timestamp. The classification accuracy was used to measure the performance. The third experiment was instance-level causal discovery. A representative sequence pair involving synergistic causal interactions was picked to highlight qualitative differences from the baselines. Statistical analysis was conducted by measuring the ratio between synergistic and non-synergistic contribution scores. For the first and second experiments, the average results based on five-fold cross-validation was reported.

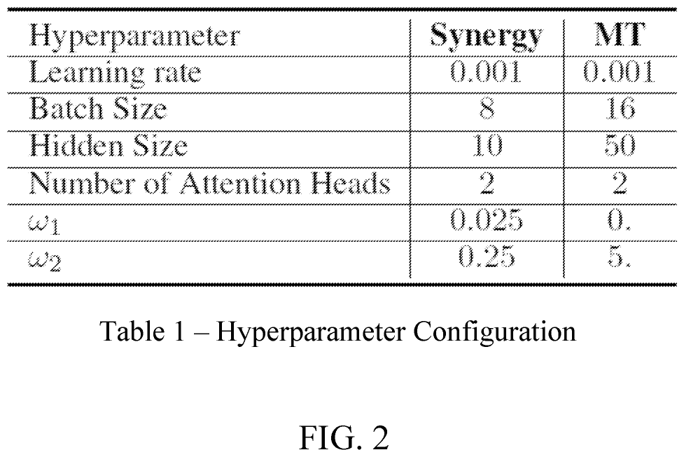

The ISAHP hyperparameter settings for Synergy and MT experiments are shown in the Table 1, provided as FIG. 2. These advanced (e.g., optimal) hyperparameter settings were selected based on five-fold cross-validation. An Adam optimizer was used for training.

### Experimental Results

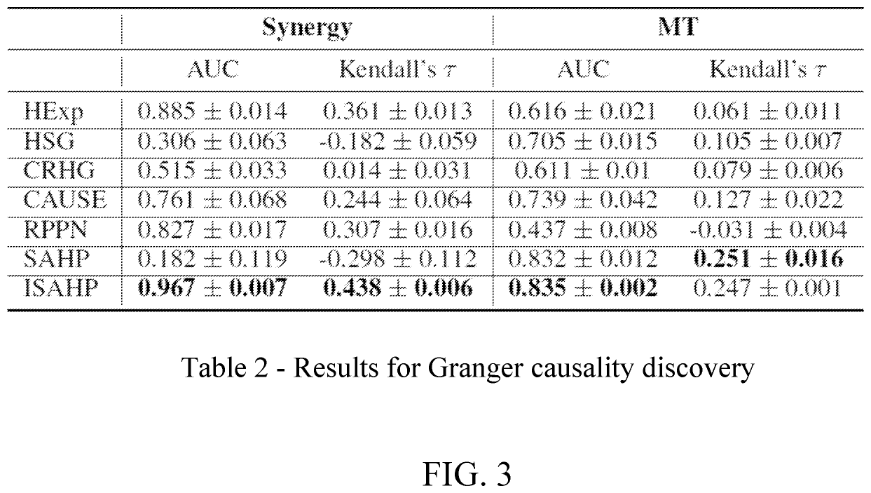

Type-level Causality Analysis. The performance on type-level Granger causality inference was analyzed. Table 2, presented as FIG. 3, exhibits the accuracy measures for Granger causality inference using AUC and Kendall's τ for ISAHP as well as six baselines. It can be seen that ISAHP generally outperforms all baselines. For AUC, it is the best among all methods. For Kendall's τ, it is the best for Synergy dataset and is almost tied with the best method (SAHP) for the MT dataset. It should be noted that ISAHP always has the smallest variance, indicating that ISAHP is the most robust.

For the MHP baselines (HExp, HSG, CRHG), it can be seen that they perform poorly for both Synergy and MT. This is expected to some extent as Synergy involves synergistic effects between multiple causes and MT is based on a real world dataset including non-linear effects. The underlying data generation mechanisms do not adhere to the linearity assumption of the (type level) intensity functions of these models.

For the two NPP baselines (RPPN, SAHP) that use the self-attention weights for (pseudo) causal attribution, it can be observed that their performance is quite unstable. SAHP reaches the start-of-the-art performance on MT dataset for Kendall's τ and is the second best on AUC, but performs the worst on the Synergy dataset. Similarly, RPPN has relatively good performance on Synergy but is the worst on MT dataset. These results indicate that using attention as attribution can be unstable depending on the data characteristics and there is no guarantee on the performance. One key issue is that they do not directly use the self-attention to parameterize the intensity function. Instead, they perform matrix multiplication between the self-attention scores and the value tensor. This step fuses information from the historical events and masks the pairwise causal relationships at the instance level. This contrasts with the approach of the present disclosure that directly uses the attention scores in the parameterization of the intensity function.

It should be noted that CAUSE is the second most robust baseline. However, it requires additional computational overhead with the post-training step which makes O(SK/B) invocations of a rather expensive attribution procedure.

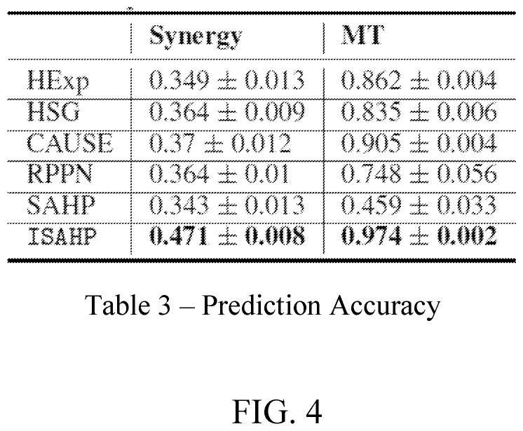

Instance-Level Event Type Prediction. The event type prediction was considered at the instance level. In Table 3, provided as FIG. 4, all the methods were computed in terms of the classification accuracy score. It is clear that ISAHP performs significantly better than all baselines on both datasets. Specifically, ISAHP reaches 27.3% relative improvement over the second best method on Synergy dataset and 7.62% relative improvement on the MT dataset.

Another interesting finding is that although SAHP performs well on the type-level Granger causality discovery for MT dataset, its event type prediction accuracy for the same dataset is the worst. A similar phenomenon is observed for RPPN on Synergy dataset. This is another indication that naively using attention for causal attribution can be unstable.

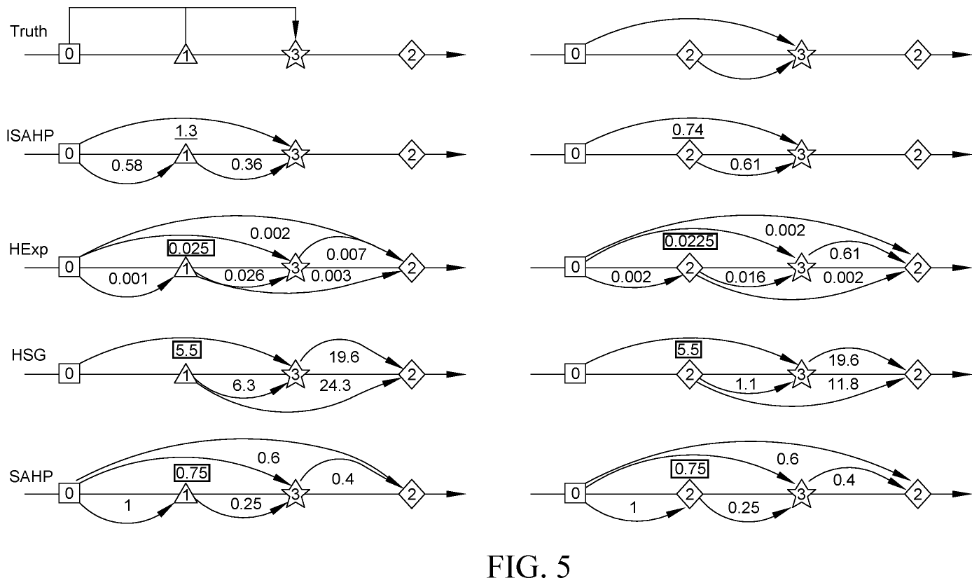

Instance-level Causality Analysis. One of the advantages of ISAHP is that it can perform accurate instance-level causality analysis. Here, anecdotal evidence of this characteristic is presented together with statistical analysis. FIG. 5 exhibits two similar event sequences that were sampled from the Synergy dataset. Each of them has four events on the timeline. Each event has been assigned a numerical label indicating its event type. The first and second events of the first sequence (on the left) have synergistic effect on the third event (as indicated by the square arrow). In contrast, in the second sequence (on the right), the first and second events have causal relationships with the third event, but independently (indicated by the rounded arrows). To be more precise, the ground truth PGEM model used to generate the data contains a type-level causal relationship (0Λ1)→3 but not (0Λ2)→3.

One would expect an effective causal attribution method to differentiate between the contribution from the first event to the third event under the synergistic and non-synergistic context. FIG. 5 shows that ISAHP successfully assigns larger contribution scores in the synergistic case, where the weight of the edge (from the first event to the third) is 1.3 for the synergistic case on the left, while the edge weight for the non-synergistic case on the right is 0.74. On the other hand, all three baselines, Hexp, HSG and SAHP fail. It can be seen that Hexp and HSG are not able to capture the synergistic effects (they assign identical weights in both cases) because they are parameterized to infer Granger causality at the type level. SAHP is intended to infer Granger causality at the instance level, but assigns essentially identical weights in the two cases.

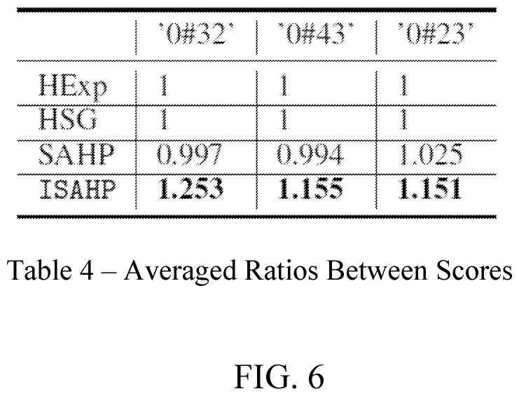

To further verify the superior performance of ISAHP, statistical analysis was performed by traversing the dataset to identify all subsequences that match the patterns ‘0#32’, ‘0#43’, and ‘0#23’, where event type #ε{0, 1, 2, 3, 4}. The synergistic effect occurs only when #=1. Table 4, presented in FIG. 6, shows the ratio of the average inferred instance-level contribution of events with type 0 to events with type 3 in the presence and absence of a synergistic effect. The result show that ISAHP always has the improved (e.g., optimal) performance compared with the baselines. ISAHP is able to achieve that because of the tight coupling between the type level and instance level causal learning. In effect, ISAHP captures synergistic effects at the type level using its additive structure at the instance level.

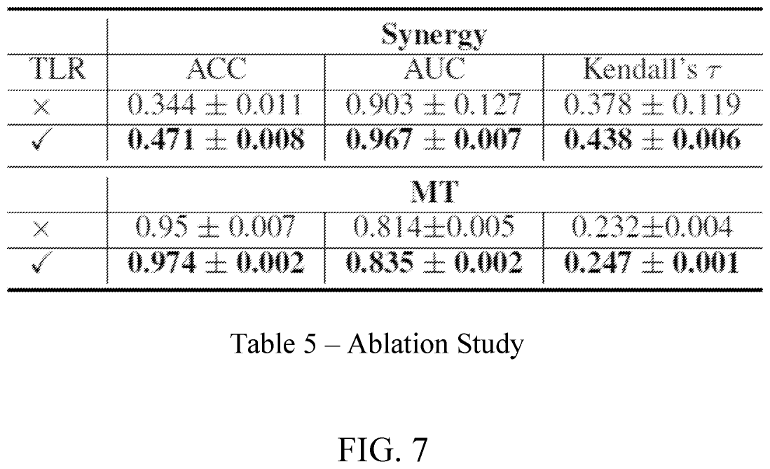

Ablation Study. Finally, an ablation study was conducted on type-level regularization (TLR) to verify that including TLR does improve ISHAP's performance. For each dataset, TLR and non-TLR cases were compared for both type-level causality analysis and type prediction, based on AUC, Kendall's τ, and accuracy (ACC). The results in Table 5, presented in FIG. 7, show that including TLR does improve the model performance for both datasets.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

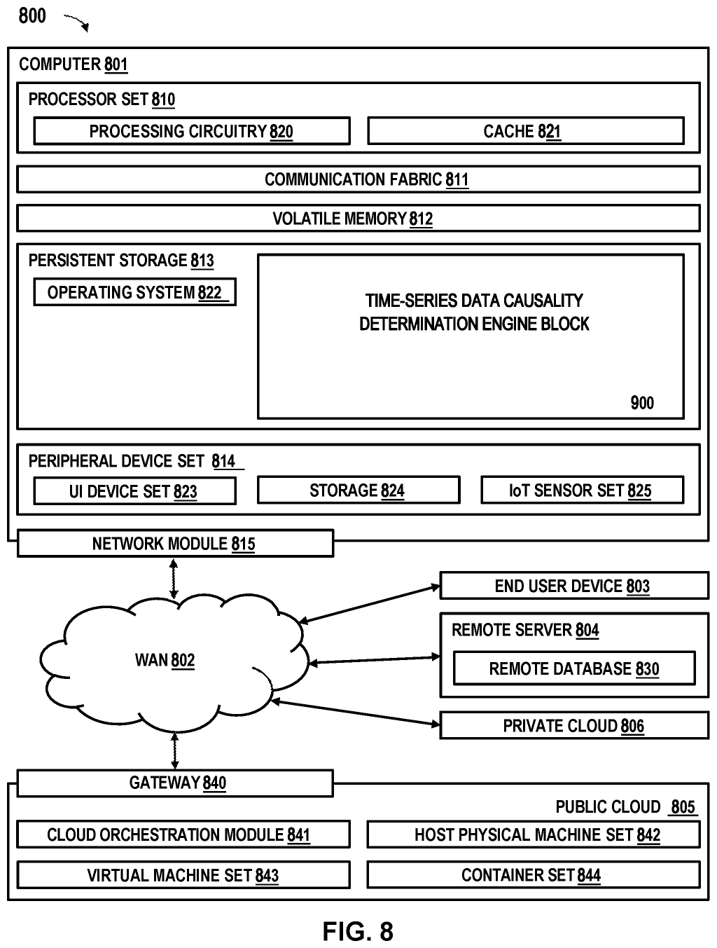

Referring to FIG. 8, computing environment 800 includes an example of an environment for the execution of at least some of the computer code involved in performing the inventive methods, including a time-series data causality determination engine block 900. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IOT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter

What is claimed is:

1. A computer-implemented method for discovering causality, the method comprising:
accessing time-series data describing past events;
inputting the time-series data into a machine learning model, the machine learning model implementing an intensity function comprising a kernel function, wherein the kernel function determines a causal strength value computed from a transformer model, and wherein the kernel function contributes to an additive function that sums intensity of repeated individual events of the past events; and
in response to the inputting, receiving output from the machine learning model that indicates a causality that links two or more events of the past events.

2. The computer-implemented method of claim 1, wherein the intensity refers to a probability density of an occurrence of an event.

3. The computer-implemented method of claim 1, wherein the transformer model implements self-attention.

4. The computer-implemented method of claim 3, wherein the self-attention is implemented via
$$A ( x , {x}_{j} ) = \frac{exp ( {x}^{T} {Kx}_{j} ) 𝕀 ( t > {t}_{j} )}{{\sum }_{l : {t}_{l} < t} exp ( {x}^{T} {Kx}_{l} )} ,$$
where t is a timestamp associated with x, and [symbol] (t>tⱼ) is an indicator function that assumes a value 1 if an argument, t>tⱼ, is true and 0 otherwise, and a transformer, K is a parameter matrix learned from data.

5. The computer-implemented method of claim 4, wherein the transformer, K, corresponds to W_{Q}W_{K}^{T}, where W_{Q} and W_{K} are transformation matrices for queries and keys, respectively.

6. The computer-implemented method of claim 1, wherein the transformer model implements a key-value-query formalism.

7. The computer-implemented method of claim 1, wherein the intensity function further comprises a decay function that contributes to the additive function.

8. The computer-implemented method of claim 7, wherein the decay function comprises a decay distribution ϕ(t-tⱼ|x, xⱼ) that models a time decay of causal influence.

9. The computer-implemented method of claim 8, wherein the decay distribution ϕ(t-tⱼ|x, xⱼ) is a truncated Gaussian mixture.

10. The computer-implemented method of claim 8, wherein
$$ϕ ( t - {t}_{j} \vert x , {x}_{j} ) = γ ( x , xj ) {e}^{- γ ( x , {x}_{j} ) ( t - {t}_{j} )} ,$$
where γ(x, xⱼ) is a decay rate function.

11. The computer-implemented method of claim 1, further comprising:
adopting an instance-aware parameterization of a kernel function, wherein:
each event is associated with a latent embedding vector x=g(t, k) and an embedding function g(t, k) is defined as:
$$g ( t , k ) = MLP [ t - {t}_{i} ⊕ MLP ( k ) ]$$
with an event type provided as a K-dimensional one-hot vector and a time difference provided as tᵢ-tᵢ₋₁, for xᵢ; and
one multilayer perceptron (MLP) layer is used to embed the K-dimensional one-hot vector for the event type; and
concatenating the one MLP layer with the time difference to form a M-dimensional embedding vector for each event (t, k).

12. The computer-implemented method of claim 11, wherein:
an intensity function for a latent event vector embedding x is in a form of:
$$λ ( x \vert {ℋ}_{t} ) = μ ( x \vert {ℋ}_{t} ) + {\sum }_{j : {t}_{j} < t} α ( x , {x}_{j} ) ϕ ( t - {t}_{j} \vert x , {x}_{j} )$$
where μ is a background intensity, a function α(x, xⱼ)εR₊, where R₊ denotes a set of nonnegative real numbers, is the kernel function; and
a decay distribution ϕ(t-tⱼ|x, xⱼ) models a time decay of causal influence.

13. The computer-implemented method of claim 1, wherein an output of the machine learning model is used, without any post-processing, to provide the output of the instance-level causality.

14. The computer-implemented method of claim 1, wherein the additive function is disposed inside a nonlinear function.

15. A system comprising:
a processor;
a data bus coupled to the processor;
a memory coupled to the data bus; and
a computer-usable medium embodying computer program code, the computer program code comprising instructions executable by the processor and configured for:
accessing time-series data describing past events;
inputting the time-series data into a machine learning model, the machine learning model implementing an intensity function comprising a kernel function, wherein the kernel function determines a causal strength value computed from a transformer model, and wherein the kernel function contributes to an additive function that sums intensity of repeated individual events of the past events; and
in response to the inputting, receiving output from the machine learning model that indicates a causality that links two or more events of the past events.

16. The system of claim 15, wherein the intensity refers to a probability density of an occurrence of an event.

17. The system of claim 15, wherein the transformer model implements self-attention.

18. A computer program product for discovering causality, the computer program product comprising a computer readable storage medium having program instructions embodied therewith, the program instructions executable by a computer to cause the computer to:
access time-series data describing past events;
input the time-series data into a machine learning model, the machine learning model implementing an intensity function comprising a kernel function, wherein the kernel function determines a causal strength value computed from a transformer model, and wherein the kernel function contributes to an additive function that sums intensity of repeated individual events of the past events; and
in response to the input, receive output from the machine learning model that indicates a causality that links two or more events of the past events.

19. The computer program product of claim 18, wherein the intensity refers to a probability density of an occurrence of an event.

20. The computer program product of claim 18, wherein the transformer model implements self-attention.
